(19) United States
(12) Patent Application Publication
(10) Pub. No.: US 2024/0144256 A1
(43) Pub. Date: May 2, 2024

(54) DECENTRALIZED BLOCKCHAIN CLIENT AUTHORIZATION AND AUTHENTICATION

(71) Applicant: VMware, Inc., Palo Alto, CA (US)

(72) Inventors: Ram Krishnan, Cupertino, CA (US); Vijaya Prakash Masilamani, Bangalore (IN); Kostas Teofanidis, Sofia (BG); Michael W. Achenbach, Los Altos, CA (US)

(21) Appl. No.: 17/977,909

(22) Filed: Oct. 31, 2022

(51) Int. Cl. G06Q 20/38; G06Q 20/36

(52) U.S. Cl. CPC G06Q 20/3829; G06Q 20/363; G06Q 20/3825

(57) ABSTRACT

This disclosure describes aspects of decentralized authorization and authentication for blockchain contracts. A permissioned blockchain includes requires decentralized approval of a particular number of users out of a specified set of users in order to approve permissioning rule updates for the permissioned blockchain. A signed blockchain request is received. The signed blockchain request specifies an action to perform with respect to the permissioned blockchain. Access to the permissioned blockchain is performed based at least in part on a confirmation that an action specified by the signed blockchain request approved according to permissioning rules of the permissioned blockchain.

### BACKGROUND

Blockchains are becoming a popular solution for enterprises to support fungible and non-fungible transactions. Blockchain transactions can enable users to access a durable history of transactions as well as the current status of transactional information. This provides additional security and trackability for transactions, providing additional security through transparency. Contracts, payments, agreements, asset records, chains of custody, ownership information, property rights, data logs, and other transactional information can be represented. Blockchains can be used as a transparent and durable way to record activity in a manner that maintains data so that it is not easily altered, corrupted, or destroyed.

However, certain aspects of blockchain techniques and infrastructures can be inefficient and ineffective. For example, permissioned blockchains can use a centralized identity and access management provider for authentication processes. This centralization can cause security problems. As a result, there is a need for more efficient and effective blockchain infrastructures.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure.

Moreover, in the drawings, like reference numerals designate corresponding parts throughout the several views.

FIG. 1 is a drawing depicting a networked environment that includes components of a blockchain architecture with decentralized access management, according to embodiments of the present disclosure.

FIG. 2 is a drawing depicting an example of decentralized access management functionalities performed by the blockchain architecture of FIG. 1, according to embodiments of the present disclosure.

FIG. 3 is a flowchart depicting functionalities performed by the blockchain architecture of FIG. 1, according to embodiments of the present disclosure.

FIG. 4 is a flowchart depicting functionalities performed by the blockchain architecture of FIG. 1, according to embodiments of the present disclosure.

FIG. 5 is a flowchart depicting functionalities performed by the blockchain architecture of FIG. 1, according to embodiments of the present disclosure.

FIG. 6 is a drawing depicting a computing device for one or more of the components of the blockchain architecture.

### DETAILED DESCRIPTION

The present disclosure describes a blockchain architecture with decentralized access management. The present disclosure improves aspects of blockchain infrastructures that can be ineffective. For example, permissioned blockchains can check user identity to ensure permission to access and modify the blockchain. These permissioned blockchains can use a centralized identity and access management provider for authentication processes. This centralization can cause security problems. Even decentralized blockchains that use such a centralized identity and access management can suffer from single-point security problems, despite the otherwise decentralized nature of the blockchain. However, the present disclosure describes mechanisms that can enable and enforce decentralized authentication and authorization for blockchain smart contracts and other blockchains. The described mechanisms also protect against exfiltration of data by enforcing a private key signature requirement for all requests associated with a blockchain.

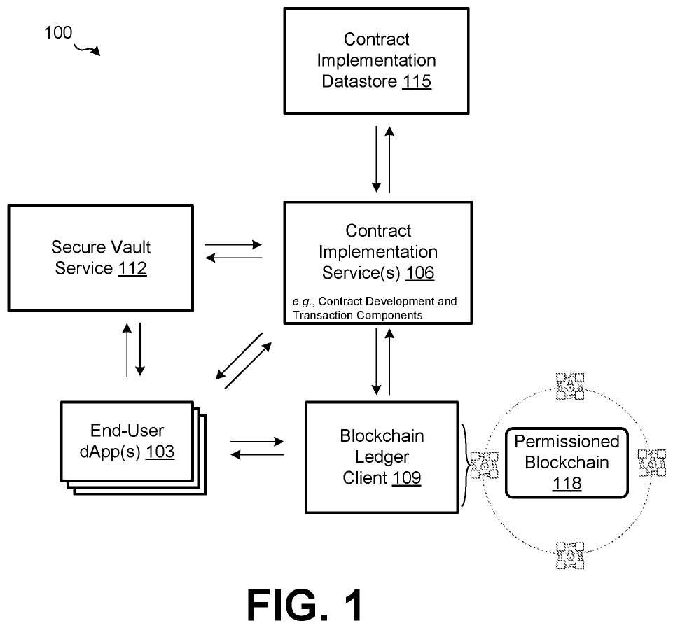

Moving to the figures, FIG. 1 shows a secure blockchain architecture 100 with decentralized access management as well as other security features. The blockchain architecture 100 can include an end-user decentralized application (dApp) 103, contract implementation services 106, a blockchain ledger client 109, a secure vault service 112, a contract implementation datastore 115, and a permissioned blockchain 118, which are in communication with one another, for example, over one or more networks.

The networks can include wide area networks (WANs), local area networks (LANs), and other networks. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The networks can also include a combination of two or more networks. Examples of networks can include the Internet, intranets, extranets, virtual private networks (VPNs), and similar networks.

The dApp 103 can include an application built on a decentralized network that includes a frontend user interface that facilitates interactions with a blockchain contract such as the permissioned blockchain 118. The dApp 103 can be executed using code running on a decentralized peer-to-peer network.

The dApp 103, which has access to an internal or external wallet, can sign all requests including reads, filter configurations, as well as writes. Support for the signature requirement for non-write requests and transactions such as reads, and filter configurations can be enabled using modified integration libraries such as web3j libraries that support signing of all types of blockchain requests. Alternatively, the contract implementation services 106 can be permissioned to use an external wallet or secure vault service 112 that manages private keys. All requests such as calls, transactions, and other requests, can be verified by the blockchain ledger client 109 or other components of the blockchain system executing a permissioned blockchain 118, to make sure they are only from permissioned end users. The identities for permissioned end users can be verified using the permissioning data stored in the blockchain itself. The blockchain system of decentralized nodes that executes the permissioned blockchain 118 is also modified to support signature verification of all requests, including those other than writes.

The contract implementation services 106 can include tools that can be used to design, develop, test, deploy, and facilitate execution of a permissioned blockchain 118. The contract implementation services 106 can include applications executed using a decentralized network or using one or more centralized server devices. The contract implementation services 106 can provide administrative or development user interfaces that enable administrators and developers to design, develop, test, and deploy a new permissioned blockchain 118. The contract implementation services 106 can also include back end services that take inputs from the dApp 103 user interface to enable execution of the permissioned blockchain 118. The dApp 103 and the blockchain ledger client 109 can work in concert with the contract implementation services 106.

The dApp 103 and the blockchain ledger client 109 can be considered contract implementation services 106, since these components work with close interaction for contract implementation. However, the dApp 103 and the blockchain ledger client 109 can be executed using the same decentralized network of nodes as code of the permissioned blockchain 118. By contrast, other components of the contract implementation services 106 can be executed separately using computing devices that can be singular, centralized, or decentralized among the various embodiments.

In other words, the contract implementation services 106 can include contract development components for design, development, testing, and deployment; and transaction components that facilitate interaction with an existing permissioned blockchain 118. Certain components of the contract implementation services 106 can include or provide administrative user interfaces using dApps 103. However, the contract implementation services 106 can provide a user interface that is not implemented using a dApp 103.

The blockchain ledger client 109 can be part of a decentralized network of executables that executes a blockchain such as the permissioned blockchain 118. The blockchain ledger client 109 can include one or more nodes of the network that provide a data transmission based interface for interactions with the permissioned blockchain 118. The blockchain ledger client 109 can provide one or more Application Programming Interfaces (APIs) that can be invoked in order to interact with the permissioned blockchain 118. The API or APIs can be invoked to read and write to the permissioned blockchain 118. This can enable any kind of contract transaction such as a transfer of tangible or intangible property from one party to another; adding, removing, and modifying contract terms; adding and removing administrative or privileged users; enabling, disabling, and modification of decentralized authentication and authorization rules for particular end-user dApps 103 for particular users, and other transactions.

The secure vault service 112 can include a service capable of safely providing dynamic secrets delivery, including management of private keys for interactions with a blockchain such as the permissioned blockchain 118. The secure vault service 112 can be a third-party service that is employed by the various components of the contract implementation services 106.

The contract implementation datastore 115 can include a datastore that is accessible to one or more of the contract implementation services 106. The contract implementation datastore 115 can be provided using a third party service accessed over a network, or can be provided using a same device that executes a portion of the contract implementation services 106. The contract implementation datastore 115 can store data structures using volatile and nonvolatile memory and data storage components. Volatile components are those that do not retain data values upon loss of power. Nonvolatile components are those that retain data upon a loss of power. This can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components.

The permissioned blockchain 118 can include a blockchain contract that includes rules or requirements for permissioning. These permissioning rules can include access permissions for reads and writes, and decentralized verification requirements for changes to to the permissioning rules. Types of permissioning rule updates or changes can include adding a user to a list of users approved for a certain type of access such as a read, a write, or a specific type of read or type of write that is defined in the permissioned blockchain 118. Types of permissioning rule updates can also include adding privileged or administrative users, and changing a threshold number or percentage of users that are required for decentralized approval of a permissioning rule update or specific type of permissioning rule update.

The permissioning rules can be stored in a permissioning block of the permissioned blockchain 118. In some examples, the first block of the permissioned blockchain 118 can include a permissioning block that specifies permissioning rules. In some examples, the permissioned blockchain 118 can require decentralized M out of N user approval for access permissions modifications performed against the permissioned blockchain 118. The permissioned blockchain 118 can also include rules that require signature verification for all actions including reads, writes, code modifications, and other types of actions against the permissioned blockchain 118.

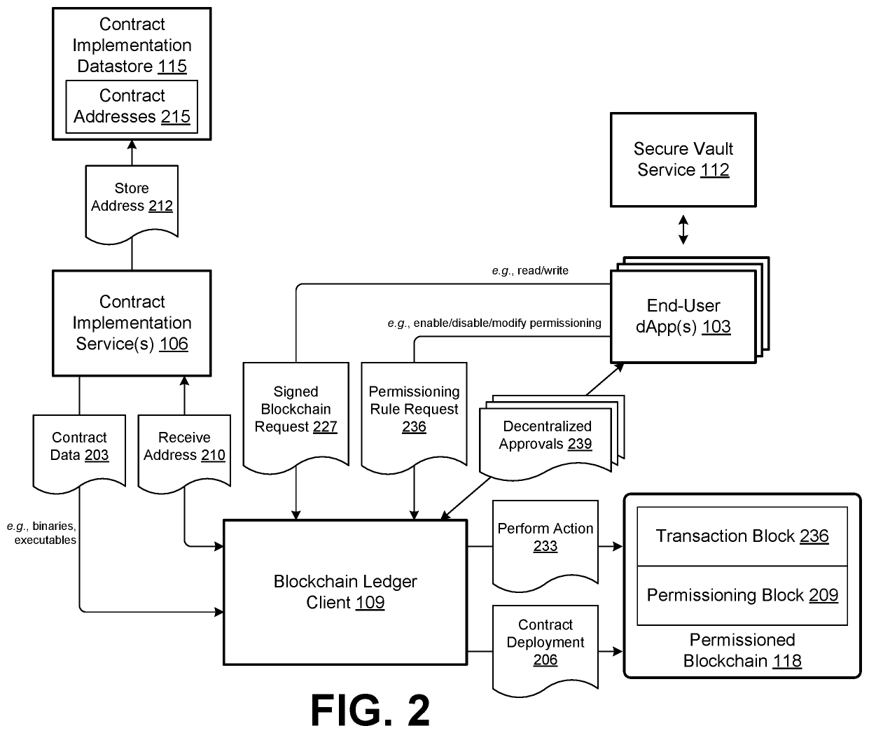

FIG. 2 shows an example of decentralized access management functionalities performed by the blockchain architecture 100. In this example, the blockchain architecture 100 can include the end-user decentralized application (dApp) 103, the contract implementation services 106, the blockchain ledger client 109, the secure vault service 112, the contract implementation datastore 115, and the permissioned blockchain 118.

The contract implementation services 106 can include a development environment for blockchain software including the permissioned blockchain 118. The contract implementation services 106 can include tools that enable developers to edit, compile, debug, and deploy permissioned blockchains 118 and associated dApps 103 in a networked environment. The contract implementation services 106 can include a user interface through which a permissioned blockchain 118 can be designed according to the desired parameters of the various parties to the contract. A dApp developer user or persona can be used to design and test the permissioned blockchain 118 using the contract implementation services 106.

The contract implementation services 106 can include a continuous integration pre-commit process that performs smart contact security analysis on the permissioned blockchain 118 that is designed through the user interface. The contract implementation services 106 can provide continuous integration, continuous delivery, and continuous deployment functionalities for the permissioned blockchain 118. This can include specification of permissioning rules for the permissioned blockchain 118.

The permissioning rules can require decentralized M out of N approval for modifications or updates to permissioning rules that enable access for a user, disable access for a user, add a privileged user, remove a privileged user, and change the approval threshold (e.g., M as a number or percentage of N). The permissioning rules can specify a list of approved users for blockchain requests. Each different type of request can have individualized rules, or all requests can abide by the same rule. The decentralized M out of N approval can refer to approval of M out of N administrative or otherwise privileged users for the permissioned blockchain 118; M out of N total users that are party to the permissioned blockchain 118; or M out of N specified users that are specified for a particular type of permissioning update transaction with the permissioned blockchain 118.

The contract implementation services 106 can provide continuous integration by allowing developers to push code changes for the permissioned blockchain 118 on demand. Once an update for the permissioned blockchain 118 is provided, the contract implementation services 106 can create an automated verification process that builds and tests the permissioned blockchain 118 executables (and associated dApp 103 executables) for stability, security, and error identification according to a predefined set of blockchain smart contract tests, guidelines, and code compliance rules.

The contract implementation services 106 can provide continuous delivery that delivers the verified permissioned blockchain 118 for manual deployment. Alternatively, the contract implementation services 106 can provide continuous deployment by automatically deploying a permissioned blockchain 118 or an update to the permissioned blockchain 118 that has passed the automated verification process.

In any case, if the permissioned blockchain 118 or the update to the permissioned blockchain 118 passes the automated verification process, then the contract implementation services 106 can store the source code in a database as verified permissioned blockchain 118 code. However, if the automated verification process fails on one or more of the predetermined tests, the contract implementation services 106 can transmit a notification a developer user. The notification can specify the security flaws in the permissioned blockchain 118. For example, the notification can indicate which tests failed, as well as which tests passed according to the automated verification process.

In some examples, compiled permissioned blockchain 118 binaries can be stored in a binary repository or another repository for artifacts, binaries, packages, files, containers, and components of the permissioned blockchain 118. Permissioned blockchain 118 binaries can be programmed and compiled in Solidity or another appropriate programming language. Storage in the binary repository can reduce compilation time for large contracts and/or minimize dependency of contract implementation services 106 on compilation of the permissioned blockchain 118.

The contract implementation services 106 can enable a “devops” persona or user to fetch a signing key from the secure vault service 112. The contract implementation services 106 can use a manually initiated process or an automated process to fetch the signing key from the secure vault service 112. The contract implementation services 106 can compile the code for the permissioned blockchain 118 using Solidarity or another appropriate language compiler.

The contract implementation services 106 can transmit contract data 203 to the blockchain ledger client 109. This transmission can deploy the permissioned blockchain 118 binary using an API exposed by the blockchain ledger client 109 as an API network endpoint. This deployment can involve signing the request using the signing key from secure vault service 112 and sending the request to the blockchain ledger client 109 API endpoint. The blockchain ledger client 109 can then implement a contract deployment 206 that causes the permissioned blockchain 118 (or update) to be executed using a decentralized network of nodes or computing devices.

The permissioned blockchain 118 can be initially deployed including a permissioning block 209. The permissioning block 209 can include a blockchain block that specifies all of the permissioning rules that were specified through the contract implementation services 106 or through an end-user dApp 103. In some examples, the permissioning block 209 can be a first block of the permissioned blockchain 118. The permissioning block 209 can include all data that enables the permissioned blockchain 118 to be a source of truth for identity management without an external identity manager service. This can include identity data for end users, administrative users, and other privileged users that are allowed or permitted to approve all or a subset of requests or transactions for the permissioned blockchain 118.

After successful deployment of the permissioned blockchain 118, including the associated end-user dApp 103 back end code, contract implementation services 106 can perform an address retrieval 210 by transmitting a request for the contract address 215 of the permissioned blockchain 118 to the blockchain ledger client 109. This can include invoking another API of the blockchain ledger client 109 or invoking the same API using a different set of parameters. Alternatively, the blockchain ledger client 109 can transmit the address automatically. In either case, the contract implementation services 106 can receive a contract address 215 for the permissioned blockchain 118 that is deployed.

The contract implementation services 106 can then invoke or implement a store address 212 action. The store address 212 action stores the contract address 215 for the permissioned blockchain 118 along with other contract addresses 215 in the contract implementation datastore 115. The contract implementation services 106 can store the contract addresses 215 in the contract implementation datastore 115 as a key-value pair. The key-value pair can include a key: “names” and values of “version,” and “contract address.” This can enable the version of the permissioned blockchain 118 and the contract address 215 of the permissioned blockchain 118 to be retrieved according to a name or unique identifier of the permissioned blockchain 118.

Once the permissioned blockchain 118 is executing, the end-user dApps 103 can be accessed by end users to perform transactions and interact with the permissioned blockchain 118. An end-user dApp 103 can provide a user interface through which a user can enter or select blockchain request data. The blockchain request data can define a particular type of request or interaction with the permissioned blockchain 118. The transaction types can include read requests as well as writes such as transfer of property, modification of contract terms, adding privileged or administrative users, and other options as discussed earlier.

The dApp 103 itself can provide a wallet that signs the blockchain request data, or can use a secure vault service 112 as an external wallet. Blockchain request data can be provided to the contract implementation services 106 or the blockchain ledger client 109 as a signed blockchain request 227. The signed blockchain request 227 can be transmitted to an endpoint such as an API endpoint exposed by the blockchain ledger client 109. The blockchain ledger client 109 can provide a number of API endpoints corresponding to different functionalities specified in various types of signed blockchain requests 227. However, in some examples, a parameter in a signed blockchain request 227 can specify a functionality such as read, write, update permissions, corresponding to different types of blockchain requests.

Alternatively, the end-user dApp 103 can provide or enter the blockchain request data to the contract implementation services 106. This request submission can use integration libraries such as web3j and others. The blockchain request data can be received from a message queue such as a Kafka message queue or another appropriate message queue. The contract implementation services 106 periodically retrieve any available blockchain request data, or the blockchain request data can be pushed to the blockchain request data when available.

The contract implementation services 106 can then perform a signing key retrieval 221 using the secure vault service 112 and an address retrieval 224 using the contract implementation datastore 115. The contract implementation datastore 115 can return a contract address 215. The key retrieval 221 can include providing a unique user identifier associated with a client device accessing the end-user dApp 103, a unique user identifier associated with the end-user dApp 103 itself, or another unique user identifier. The secure vault service 112 can sign the blockchain request data using an appropriate private key, or can provide a private key or another signing key that the contract implementation services 106 use to generate the signed blockchain request 227 using the blockchain request data. The contract implementation services 106 can then transmit the signed blockchain request 227 to the blockchain ledger client 109 through an appropriate API exposed by the blockchain ledger client 109.

The signed blockchain request 227 can include a “from” field and a “to” field. The value of the “from” field can include an account address or account identifier, which can be used to identify the end-user dApp 103. The value of the “to” field can be the contract address 215 of the permissioning blockchain 118, which can be used to identify the permissioning blockchain 118. Alternatively, the “to” field can be used by the contract implementation services 106 or the blockchain ledger client 109 to retrieve the contract address 215.

The blockchain ledger client 109, or alternatively the contract implementation services 106, can verify that the end-user dApp 103 is approved to perform the type of request specified in the signed blockchain request 227. The blockchain ledger client 109 can verify approval for the type of request using the permissioned blockchain 118 as a source of truth. For example, the blockchain ledger client 109 can read the permissioned blockchain 118 corresponding to the contract address 215. The blockchain ledger client 109 can use the information in a permissioning block 209 to confirm that the signed blockchain request 227 originates from a user that is approved for the specific type of request specified in the signed blockchain request 227. The identity of the user can be confirmed using one or both of the signature in the signed blockchain request 227 and the account identifier. If the user is approved according to the permissioning rules in the permissioning block 209, the blockchain ledger client 109 can perform an action 233 that corresponds to the request specified in the signed blockchain request 227.

Another process can be carried out in the case of a permissioning rule request 236. The permissioning rule request 236 can specify a request to apply new permissioning rules, modify permissioning rules, remove permissioning rules, or otherwise update the blockchain using permissioning rules. This can include enabling, disabling, or modifying the ability of specified end users from particular actions. The actions can include reads, writes, and even specific types of reads and writes that can be defined within the permissioned blockchain 118. The permissioning rule request 236 can be a signed blockchain request 227 that specifies a type of write corresponding to new or updated permissioning rules.

A permissioning rule request 236 can be a signed request generated and transmitted by an end-user dApp 103 or a contract implementation services 106. The contract implementation services 106 can form a signed permissioning rule request 236 in the same manner as described for the signed blockchain request 227. The permissioning rule request 236 can be signed by the end-user dApp 103. The blockchain ledger client 109 can identify that the permissioning rule request 236 includes an update to a permissioning rule.

The blockchain ledger client 109 can identify this based on a parameter in the permissioning rule request 236, or based on the API invoked to submit the permissioning rule request 236. The blockchain ledger client 109 can read the permissioned blockchain 118 and use the information in a permissioning block 209 to confirm that the permissioning rule request 236 originates from a user that is an administrator or otherwise privileged user that is approved for the permissioning rule update specified in the permissioning rule request 236. The blockchain ledger client 109 can also identify a decentralized approval requirement specified in the permissioned blockchain 118 for permissioning rule updates.

The decentralized approval requirement can require the decentralized approvals 239 prior to enabling the blockchain ledger client 109 to write an additional permissioning block 209 as specified in the permissioning rule request 236. The blockchain ledger client 109 can determine whether decentralized approvals 239 are received for the permissioning rule request 236. In some examples, the blockchain ledger client 109 or the contract implementation services 106 can transmit requests for decentralized approvals 239. The blockchain ledger client 109 can confirm that the decentralized approvals 239 that are received include M approvals out of N users specified as privileged to approve permissioning rule updates. Each of the decentralized approvals 239 can be signed using a corresponding private key of a user that is specified by the permissioned blockchain 118 as one of the N users privileged to approve permissioning rule updates. The decentralized approvals 239 can include account identifiers or addresses that are indicated to be privileged users of the permissioned blockchain 118. Once M approvals out of N users are received and confirmed against the permissioned blockchain 118, the blockchain ledger client 109 can write an additional permissioning block 209 that includes the permissioning rule update.

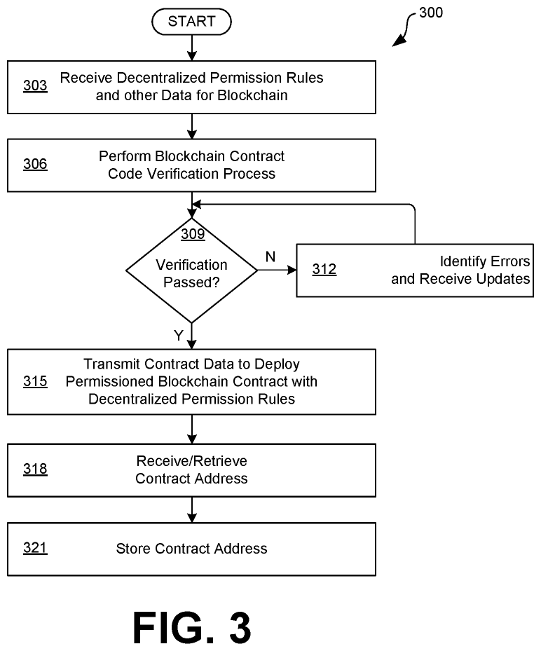

FIG. 3 shows a flowchart 300 that provides an example of decentralized access management functionalities performed by the blockchain architecture 100. Generally, the flowchart 300 shows how contract implementation services 106 can design, test, and deploy a permissioned blockchain 118 that enforces decentralized approval rules. While a particular step of the flowchart 300 can be described as being implemented by a particular component of the blockchain architecture 100, other components can perform certain aspects of the various steps.

In step 303, the contract implementation services 106 can receive decentralization rules and other data for a permissioned blockchain 118. The contract implementation services 106 can provide administrative or development user interfaces that enable administrators and developers to design, develop, test, and deploy a new permissioned blockchain 118. The contract implementation services 106 can also provide a user interface to design back end services. The user interface elements of the contract implementation services 106 can design and update the dApps 103 and other executable components that enable execution of the permissioned blockchain 118.

The contract implementation services 106 can provide user interface elements that enable a user to specify permissioning rules for the permissioned blockchain 118. The permissioning rules can require decentralized M out of N approval for permissioning rule updates. The permissioning rules can also specify a list of approved users for blockchain access requests such as read requests and write requests. Each different type of request can have individualized rules, or all requests can abide by the same rule. The decentralized M out of N approval can refer to approval of M out of N administrative or otherwise privileged users for the permissioned blockchain 118; M out of N total users that are party to the permissioned blockchain 118; or M out of N specified users that are specified for a particular type of permissioning update transaction with the permissioned blockchain 118.

In step 306, the contract implementation services 106 can perform a blockchain contract code verification process for the permissioned blockchain 118. The contract implementation services 106 can enable developers to push code changes for the permissioned blockchain 118 on demand. Once an update for the permissioned blockchain 118 is provided, the contract implementation services 106 can perform the verification process to test the permissioned blockchain 118 code and executables for stability, security, and error identification according to a predefined set of blockchain smart contract tests, guidelines, and other code compliance rules.

In step 309, the contract implementation services 106 can determine whether the verification process is passed or failed. Success or failure of the permissioned blockchain 118 can be predicated on thresholds set by the blockchain contract code compliance rules. For some types of errors, the error alone can indicate failure. In other cases, a specified threshold number of errors over time or a threshold likelihood or chances for an error to occur can indicate a success or a failure. If the verification process has failed, the process can move to step 312. If the verification process has passed, the process can move to step 315.

In step 312, the contract implementation services 106 can provide a notification and user interface that identifies errors and receives updates to the code of the permissioned blockchain 118. For example, the contract implementation services 106 can generate a user interface that surfaces a notification indicating that the permissioned blockchain 118 has failed. The user interface can also point out a list of errors that specifies a type of error and a section of code that is associated with each error. A user can use the contract implementation services 106 to implement one or more recommended changes or manually correct the errors. These updates can be applied to the permissioned blockchain 118 and the verification process can run again. This process can be repeated until the permissioned blockchain 118 passes the verification process or a user overrides the failure state.

In step 315, the contract implementation services 106 can transmit contract data to deploy the permissioned blockchain 118. The contract implementation services 106 can transmit contract data 203 to the blockchain ledger client 109. This transmission can deploy the permissioned blockchain 118 binary using an API exposed by the blockchain ledger client 109 as an API network endpoint. This deployment can involve signing the request using the signing key from secure vault service 112 and sending it to the blockchain ledger client 109 API endpoint. The blockchain ledger client 109 can then implement a contract deployment 206 that causes the permissioned blockchain 118 (or update) to be executed using a decentralized network of nodes or computing devices. The permissioned blockchain 118 can be initially deployed including a permissioning block 209. The permissioning block 209 can include a blockchain block that specifies all of the permissioning rules that were specified through the contract implementation services 106 or through an end-user dApp 103.

In step 318, the contract implementation services 106 can receive or retrieve a contract address for the permissioned blockchain 118. After successful deployment of the permissioned blockchain 118 and the associated end-user dApp 103 back end code, contract implementation services 106 can perform an address retrieval 210 by transmitting a request for the contract address 215 of the permissioned blockchain 118 to the blockchain ledger client 109. This can include invoking another API of the blockchain ledger client 109 or invoking the same API using a different set of parameters. Alternatively, the blockchain ledger client 109 can transmit the address automatically. In either case, the contract implementation services 106 can receive a contract address 215 for the permissioned blockchain 118 that is deployed.

In step 321, the contract implementation services 106 can store the contract address for the permissioned blockchain 118. The contract implementation services 106 can then store the contract address 215 for the permissioned blockchain 118 along with other contract addresses 215 in the contract implementation datastore 115. The contract implementation services 106 can store the contract addresses 215 in the contract implementation datastore 115 as a key-value pair. The key-value pair can include a key: “names” and values of “version,” and “contract address.” This can enable the version of the permissioned blockchain 118 and the contract address 215 of the permissioned blockchain 118 to be retrieved according to a name or unique identifier of the permissioned blockchain 118.

This storage of the contract addresses 215 can enable other aspects of the contract implementation services 106 to transmit requests for addition as a block of the permissioned blockchain 118. The permissioned blockchain 118 can be used as a source of truth for authorization and authentication. In some cases, the data used as a source of truth can be a permissioning block 209. The deployed permissioned blockchain 118 can also require decentralized approvals 239 according to permissioning rules specified in the permissioning block 209. The permissioned blockchain 118 can be a source of truth for authentication and authorization of all aspects of a particular blockchain request. For example, the permissioned blockchain 118 can be used for authentication and authorization of the user that originates a blockchain request, as well as authentication and authorization of all users associated with decentralized approvals 239.

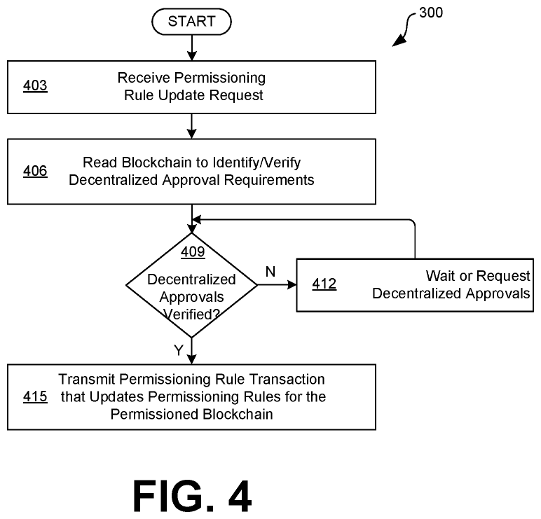

FIG. 4 shows a flowchart 400 that provides an example of decentralized access management functionalities performed by the blockchain architecture 100. Generally, the flowchart 400 shows how the secure blockchain architecture 100 can enforce decentralized approval for changes to permissioning rules for a permissioned blockchain 118. While a particular step of the flowchart 400 can be described as being implemented by the blockchain ledger client 109, the contract implementation services 106, or the end-user dApps 103 can alternatively perform the primary aspects of these steps. Other components can also perform certain aspects of the various steps.

In step 403, the blockchain ledger client 109 can receive a permissioning rule request 236. The permissioning rule request 236 can specify a request to apply new permissioning rules, modify permissioning rules, remove permissioning rules, or otherwise update the blockchain using permissioning rules. This can include enabling, disabling, or modifying the ability of specified end users from particular actions.

In step 406, the blockchain ledger client 109 can read the permissioned blockchain 118 to identify or verify decentralized rule requirements. The blockchain ledger client 109 can use the information in a permissioning block 209 or another block of the permissioned blockchain 118 to identify or verify decentralized rule requirements. For example, the blockchain ledger client 109 can confirm that the permissioning rule request 236 originates from a user that is an administrator or otherwise privileged user that is approved for the permissioning rule update specified in the permissioning rule request 236. The blockchain ledger client 109 can also identify a decentralized approval requirement specified in the permissioned blockchain 118 for permissioning rule updates.

In step 409, the blockchain ledger client 109 can determine whether decentralized approval has been confirmed for the signed blockchain request 227. The blockchain ledger client 109 can use rules specified in the permissioned blockchain 118 to enforce this requirement. The decentralized approval requirement can require the decentralized approvals 239 prior to enabling the blockchain ledger client 109 to write an additional permissioning block 209 as specified in the permissioning rule request 236. The blockchain ledger client 109 can determine whether decentralized approvals 239 are received for the permissioning rule request 236.

The blockchain ledger client 109 can confirm that the decentralized approvals 239 that are received include M approvals out of N users specified as privileged to approve permissioning rule updates. Each of the decentralized approvals 239 can be signed using a corresponding private key of a user that is specified by the permissioned blockchain 118 as one of the N users privileged to approve permissioning rule updates. The decentralized approvals 239 can include account identifiers or addresses that are indicated to be privileged users of the permissioned blockchain 118. The blockchain ledger client 109 can use the data read from the permissioned blockchain 118 in order to verify that the decentralized approvals 239 correspond to users specified as privileged to approve permissioning rule updates based on the account identifiers and the signatures.

If the decentralized approvals 239 are not received and verified, then the process can request or wait for decentralized approvals in step 412 until sufficient approvals are received and verified according to the rules in the permissioned blockchain 118. Once the decentralized approvals 239 are received then the process can move to step 415.

In step 415, the blockchain ledger client 109 can write a block to the permissioned blockchain 118 that updates the per missioning rules. For example, the blockchain ledger client 109 can cause the blockchain nodes to write an additional permissioning block 209 as specified in the permissioning rule request 236.

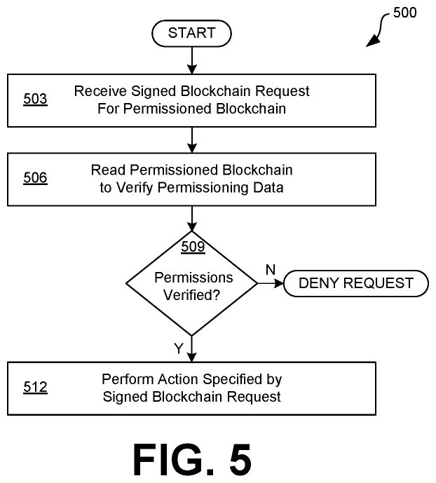

FIG. 5 shows a flowchart 500 that provides an example of decentralized access management functionalities performed by the blockchain architecture 100. Generally, the flowchart 400 shows how the secure blockchain architecture 100 can enforce permissions for all requests to a permissioned blockchain 118, including all read requests. While a particular step of the flowchart 400 can be described as being implemented by the blockchain ledger client 109, the contract implementation services 106, or the end-user dApps 103 can alternatively perform the primary aspects of these steps. Other components can also perform certain aspects of the various steps.

In step 503, the blockchain ledger client 109 can receive a signed blockchain request 227. The dApp 103 can provide a wallet that signs blockchain request data to generate a signed blockchain request 227. Alternatively, the dApp 103 can use a secure vault service 112 as an external wallet that signs blockchain request data to generate a signed blockchain request 227. The signed blockchain request 227 can be received at an endpoint exposed by the blockchain ledger client 109.

In step 506, the blockchain ledger client 109 can read the permissioned blockchain 118 to verify permissioning data. For example, the blockchain ledger client 109 can read the permissioned blockchain 118 referenced by the signed blockchain request 227. The blockchain ledger client 109 can identify a set of users that are approved to access the permissioned blockchain 118 generally, or a set of users specified specifically for a type of action indicated by the signed blockchain request 227. For example, reads can be approved for a first set of user accounts while writes are approved for another set of accounts. In some examples, the permissioned blockchain 118 can approve different sets of users for each type of transaction that is specified according to multiple categories of transactions that are defined in the permissioned blockchain 118.

In step 509, the blockchain ledger client 109 can determine whether the permissions are verified for the signed blockchain request 227. The blockchain ledger client 109 can use the information in a permissioning block 209 to confirm that the signed blockchain request 227 originates from a user that is approved for the specific type of request specified in the signed blockchain request 227. The identity of the user can be confirmed using one or both of the signature in the signed blockchain request 227 and the account identifier. If permissions are not verified, for example, if the blockchain request 227 originates from a user that is not listed as an approved users for the type of action specified, then the blockchain ledger client 109 can deny the blockchain request 227.

In step 512, if the user is approved according to the permissioning rules in the permissioning block 209, then the blockchain ledger client 109 can perform an action 233 that corresponds to the request specified in the signed blockchain request 227.

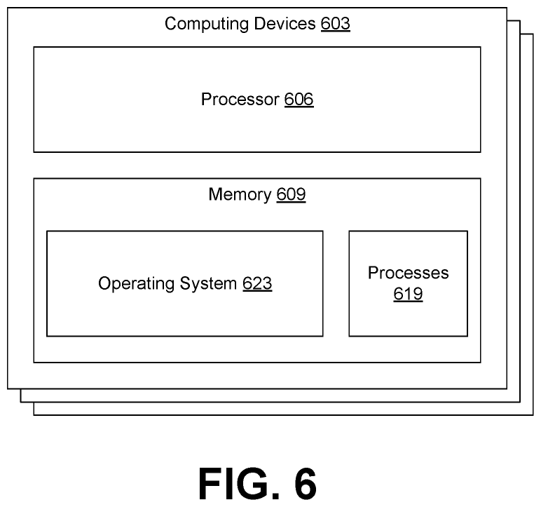

FIG. 6 depicts a schematic block diagram of one example of one or more computing devices 603 for the components of the networked environment of FIG. 1, according to various embodiments of the present disclosure. A computing device 603 can have one or more processors 606. The computing device 603 can also have a memory 609.

The processor 606 can represent any circuit or combination of circuits that can execute one or more machine-readable instructions stored in the memory 609 that make up a computer program or process and store the results of the execution of the machine-readable instructions in the memory 609. In some implementations, the processor 606 may be configured to perform one or more machine-readable instructions in parallel or out of order. This could be done if the processor 606 includes multiple processor cores and/or additional circuitry that supports simultaneous multithreading (SMT). Examples of a processor 606 can include a central processing unit (CPU), a graphics processing unit (GPU), a field-programmable gate array (FPGA), application specific integrated circuits (ASICs), etc.

The memory 609 can include both volatile and nonvolatile memory and data storage components. Volatile components are those that do not retain data values upon loss of power. Nonvolatile components are those that retain data upon a loss of power. Thus, the memory 609 can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device. Various types of data and machine-readable instructions may be stored in the memory 609. For example, one or more processes 619 may be stored in the memory 609. In some implementations, an operating system 623 may also be stored in the memory 609.

A process 619 can represent a collection of machine-readable instructions stored in the memory 609 that, when executed by the processor 606 of the computing device 603, cause the computing device 603 to perform one or more tasks. A process 619 can represent a program, a sub-routine or sub-component of a program, a library used by one or more programs, etc. When a process requests access to a hardware or software resource for which it lacks permission to interact with, the process 619 can generate an interrupt and provide or send the interrupt to the operating system 623.

The operating system 623 can include any system software that manages the operation of computer hardware and software resources of the computing device 603. The operating system 623 can also provide various services or functions to computer programs, such as processes 619, that are executed by the computing device 603. Accordingly, the operating system 623 may schedule the operation of tasks or processes 619 by the processor 606, act as an intermediary between processes 619 and hardware of the computing device 603. The operating system 623 may also implement and/or enforce various security safeguards and mechanisms to prevent access to hardware or software resources by unprivileged or unauthorized users or processes 619.

The operating system 623 can also implement a virtual memory system that provides an abstract representation of the memory 609 available on the computing device 603, such as the RAM. Among the features provided by the virtual memory system are a per process 619 address space, which maps virtual addresses used by a process 619 to physical addresses of the memory 609. The processor's memory management unit (MMU) can translate these virtual addresses to physical addresses, when used. The operating system 623 can use the virtual memory system to present more memory 609 to individual processes 619 than is physically available.

A number of software components discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), persistent memory, hard drive, solid-state drive, Universal Serial Bus (USB) flash drive, memory card, optical disc such as compact disc (CD) or digital versatile disc (DVD), floppy disk, magnetic tape, or other memory components.

Memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, graphics processing units (GPUs), field-programmable gate arrays (FPGAs), or other components, etc. Such technologies are generally well known by those skilled in the art and, consequently, are not described in detail herein.

Flowcharts can be used to describe the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although flowcharts can show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. While concepts of the present disclosure are discussed with respect to a particular figure, the concepts can also be used in connection with the other figures. All such modifications and variations are intended to be included herein within the scope of this disclosure and protected by the following claims.

Therefore, the following is claimed:

1. A system, comprising:
at least one computing device comprising at least one processor; and
at least one memory comprising executable instructions, wherein the instructions are executed to cause the at least one computing device to at least:
execute a permissioned blockchain that requires decentralized approval of a particular number of users out of a specified set of users in order to approve permissioning rule updates for the permissioned blockchain;
receive a signed blockchain request that specifies a permissioning rule update for the permissioned blockchain, wherein the signed blockchain request is signed using an end-user private key; and
write a block to the permissioned blockchain based at least in part on a confirmation that the particular number of users out of the specified set of users have approved the permissioning rule update.

2. The system of claim 1, wherein the permissioning rule update specifies to add at least one user to a list of users approved to perform at least one type of access to the permissioned blockchain.

3. The system of claim 1, wherein the signed blockchain request is signed using a decentralized application that originated the signed blockchain request.

4. The system of claim 1, wherein the signed blockchain request is signed using a secure vault or an external wallet.

5. The system of claim 1, wherein the permissioned blockchain requires decentralized approval based on a rule specified in a permissioning block of the permissioned blockchain.

6. The system of claim 5, wherein the permissioning block is a first block of the permissioned blockchain.

7. The system of claim 1, wherein the permissioned blockchain is used as a source of truth for authentication and authorization of a user that initiates the signed blockchain request, and a set of users corresponding to a set of decentralized approvals for the signed blockchain request.

8. A non-transitory computer readable medium comprising machine-readable instructions that, when executed, cause at least one computing device to at least:
execute a permissioned blockchain that requires decentralized approval of a particular number of users out of a specified set of users in order to approve permissioning rule updates for the permissioned blockchain;
receive a signed blockchain request that specifies an action to perform using the permissioned blockchain, wherein the signed blockchain request is signed using an end-user private key; and
perform the action using the permissioned blockchain based at least in part on a confirmation that the end-user private key is specified in the permissioned blockchain to be approved to perform the action.

9. The non-transitory computer readable medium of claim 8, wherein the action is a read action, and the signed blockchain request is a signed blockchain read request to read at least a portion of the permissioned blockchain.

10. The non-transitory computer readable medium of claim 8, wherein the signed blockchain request is signed using a decentralized application that originated the signed blockchain request.

11. The non-transitory computer readable medium of claim 8, wherein the signed blockchain request is signed using a secure vault or an external wallet.

12. The non-transitory computer readable medium of claim 8, wherein the permissioned blockchain requires decentralized approval based on a rule specified in a permissioning block of the permissioned blockchain.

13. The non-transitory computer readable medium of claim 8, wherein the permissioned blockchain specifies the end-user private key to be approved to perform the action in a permissioning block of the permissioned blockchain.

14. The non-transitory computer readable medium of claim 8, wherein the permissioned blockchain is used as a source of truth for authentication and authorization of a user that initiates the signed blockchain request, and a set of users corresponding to a set of decentralized approvals for the signed blockchain request.

15. A method comprising:
executing a permissioned blockchain that requires decentralized approval of a particular number of users out of a specified set of users in order to approve permissioning rule updates for the permissioned blockchain;
receiving a signed blockchain request that specifies a permissioning rule update for the permissioned blockchain, wherein the signed blockchain request is signed using an end-user private key; and
writing a block to the permissioned blockchain based at least in part on a confirmation that the particular number of users out of the specified set of users have approved the permissioning rule update.

16. The method of claim 15, wherein the permissioning rule update specifies to add at least one user to a list of users approved to perform at least one type of access to the permissioned blockchain.

17. The method of claim 15, wherein the signed blockchain request is signed using a decentralized application that originated the signed blockchain request.

18. The method of claim 15, wherein the signed blockchain request is signed using a secure vault or an external wallet.

19. The method of claim 15, wherein the permissioned blockchain requires decentralized approval based on a rule specified in a permissioning block of the permissioned blockchain.

20. The method of claim 15, wherein the permissioned blockchain is used as a source of truth for authentication and authorization of a user that initiates the signed blockchain request, and a set of users corresponding to a set of decentralized approvals for the signed blockchain request.
